(19) United States
(12) Patent Application Publication
(10) Pub. No.: US 2021/0024246 A1
(43) Pub. Date: Jan. 28, 2021

(54) SHIPPING CARTON WITH TRANSPARENT SECURITY WINDOWS

(71) Applicant: Gary M. Bell, Crystal, MN (US)

(72) Inventor: Gary M. Bell, Crystal, MN (US)

(21) Appl. No.: 16/936,957

(22) Filed: Jul. 23, 2020

Related U.S. Application Data
(60) Provisional application No. 62/879,078, filed on Jul. 26, 2019.

(51) Int. Cl. B65D 5/42; B65D 5/02; B65D 59/04; G01N 21/90; G01N 21/88

(52) U.S. Cl. CPC B65D 5/4204; B65D 5/0236; G01N 2021/8887; G01N 21/90; G01N 21/8851; B65D 59/04

(57) ABSTRACT

In some embodiments, a shipping carton has a front side defining four front edges and a back side defining four back edges, the front and back sides joined together by four lateral sides so that the carton defines an interior space. The front side includes at least one front transparent section in visual communication with the interior space and the back side includes at least one back transparent section in visual communication with the interior space. In other embodiments, a tubular shipping carton has a front portion that includes at least one front transparent section in visual communication with an interior space defined by a major surface of the tube and a back portion that includes at least one back transparent section in visual communication with the interior space.

### CROSS-REFERENCE TO RELATED APPLICATIONS

This application claims priority to U.S. provisional application Ser. No. 62/879,078, filed Jul. 26, 2019 and titled SHIPPING CARTON WITH TRANSPARENT SECURITY WINDOWS, the entire contents of which are incorporated herein by reference.

### FIELD OF THE INVENTION

The invention generally relates to shipping cartons that provide the ability to see what is inside the carton.

### DESCRIPTION OF THE RELATED ART

Known shipping cartons generally do not allow a visualization of potentially dangerous substances or materials held therein. There are paper envelopes that provide a transparent window for the recipient's address, generally located in the middle portion of the front side of the envelope, and the sender's address, generally located in the upper left corner of the front side of the envelope. However, larger envelopes and other shipping devices such as shipping cartons do not provide a viewing window for visualization of potentially dangerous substances or objects, e.g., dangerous powders, illicit drugs, explosives, weapons, or the like contained therein.

The present invention overcomes these deficiencies and provides, inter alia, the above-referenced improvements.

### BRIEF SUMMARY OF THE INVENTION

A shipping carton container comprising substantially opaque front and back major sides joined together by four substantially opaque lateral sides, with at least one transparent section defined on the front side of the carton and at least one transparent section defined on the back side of the carton. Alternatively, a tubular shipping carton comprising a substantially opaque curved major surface positioned between first and second substantially opaque end surfaces, with at least one transparent section defined on each of a front portion and a back portion of the curved major surface. The transparent sections allow visualization of contents therein for detection of dangerous substances or objects as dangerous powders, illicit drugs, explosives, weapons, or the like, and/or confirmation that no such dangerous substances or objects are present in the carton without necessitating opening of the shipping carton.

In one embodiment, a shipping carton comprises a front side defining four front edges and a back side defining four back edges, the front and back sides joined together by four lateral sides, the four lateral sides positioned between the front and back sides such that the shipping carton defines an interior space extending between the front, back, and lateral sides, wherein the front side comprises at least one front transparent section in visual communication with the interior space and the back side comprises at least one back transparent section in visual communication with the interior space.

In another embodiment, a tubular shipping carton comprises a curved major surface comprising a front portion and a contiguous back portion; a first end surface; and a second end surface, wherein the major surface is positioned between the first and second end surfaces such that the shipping carton defines an interior space extending between the first and second end surfaces, and wherein the front portion of the major surface comprises at least one front transparent section in visual communication with the interior space and the back portion comprises at least one back transparent section in visual communication with the interior space.

In another embodiment, a method for assessing a closed and sealed shipping carton for potentially dangerous substances or objects disposed within the carton comprises: receiving a closed and sealed shipping carton according to one of the embodiments described herein; inspecting the interior space of the received shipping carton through one or more of the at least one front transparent section and the at least one back transparent section for potentially dangerous substances or objects; and determining if the interior space of the closed and sealed enveloping container contains a potentially dangerous substance or object.

The description of the invention and its applications as set forth herein is illustrative and is not intended to limit the scope of the invention. Features of various embodiments may be combined with other embodiments within the contemplation of this invention. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention.

### BRIEF DESCRIPTION OF THE DRAWINGS

FIG. 1 is a front perspective view of a front side of an embodiment of a shipping carton having a front side and a back side joined together by four lateral sides, the front side comprising a plurality of transparent sections.

FIG. 2 is a rear view of the shipping carton of FIG. 1, the back side comprising a plurality of transparent sections.

FIG. 3 is a front perspective view of a front side of an embodiment of a shipping carton having a front side and a back side joined together by four lateral sides, the front side comprising one continuous transparent section.

FIG. 4 is a rear view of the shipping carton of FIG. 3, the back side comprising one continuous transparent section.

FIG. 5 is a front perspective view of a front side of an embodiment of a tubular shipping carton having a curved major surface comprising a front portion and a contiguous back portion positioned between the first and second end surfaces, the front portion comprising a plurality of transparent sections.

FIG. 6 is a rear view of the shipping carton of FIG. 5, the back portion comprising a plurality of transparent sections.

FIG. 7 is a front perspective view of a front side of an embodiment of a tubular shipping carton having a curved major surface comprising a front portion and a contiguous back portion positioned between the first and second end surfaces, the front portion comprising one continuous transparent section.

FIG. 8 is a rear view of the shipping carton of FIG. 7, the back portion comprising one continuous transparent section.

### DETAILED DESCRIPTION

While the invention is amenable to various modifications and alternative forms, specifics thereof are shown by way of example in the drawings and described in detail herein. It should be understood, however, that the intention is not to limit the invention to the particular embodiments described. On the contrary, the intention is to cover all modifications, equivalents, and alternatives falling within the spirit and scope of the invention.

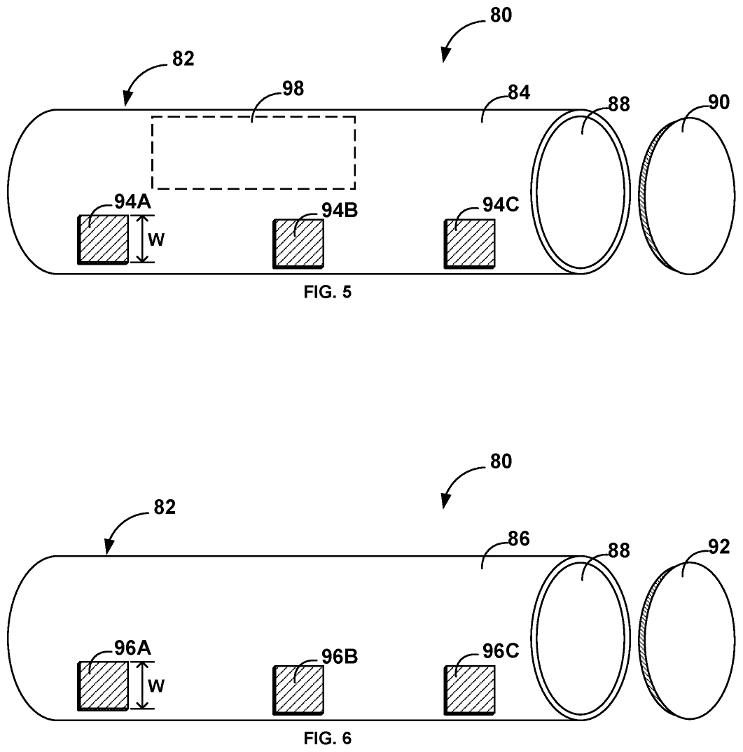

FIGS. 1-8 illustrate embodiments of the shipping cartons of the present invention that have one or more transparent security windows. The embodiments shown in FIGS. 1-8 may include one or more general features that may be included in any embodiment of the present invention, alone or in any combination. One or more embodiments of the shipping cartons may be in the form of a box as shown in the embodiments of FIGS. 1-4, although in other examples the shipping cartons may be in the form of a tube as shown in the embodiments of FIGS. 5-8, or any other suitable form. In such examples, the shipping cartons may be formed from a primary material comprising cardboard, paperboard, polymer composition, or any other suitable material or blend thereof. However, it should be understood that the shipping cartons of the present invention may have any other suitable configuration or shape, such a variation of the box shape shown in FIGS. 1-4 or a variation of the tubular shape shown in FIGS. 5-8. In any such examples, the primary material of the shipping carton may be suitable for applying desired images and/or words thereto (e.g., branding logos, images, and/or words). In other examples, the shipping carton may include a printed layer of material laminated or otherwise affixed to an outer surface of the primary material.

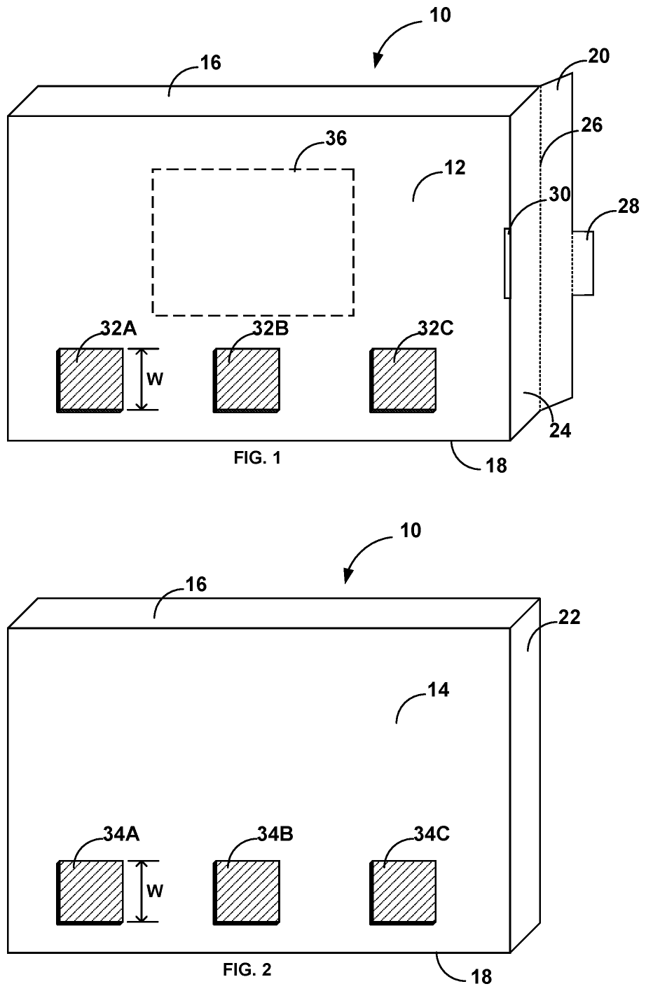

With reference to FIGS. 1 and 2, shipping carton 10 comprises a front side 12 and a back side 14. The front side 12 and the back side 14 are joined together by four lateral sides 16, 18, 20, and 22 that are adjacent the four edges of front side 12 and back side 14. One or more of the lateral sides 16, 18, 20, and 22 comprise one or more flaps defining a corresponding opening 24 through which materials to be shipped are slid into an interior space defined within the shipping carton 10, as is commonly known with sealable shipping cartons. In the embodiment of FIGS. 1 and 2, lateral side 20 comprises the flap. When the flap is open, the lateral side 20 is connected only to the back side 14 along edge 26, which functions as a hinge on which the flap pivots. In this embodiment, the lateral side 20 further defines a tab 28 that is dimensioned to be received in slot 30, which is defined by the front side 12. In other embodiments (not shown), the lateral side 20 may comprise two flaps, one extending from the back side 14 as shown and the other flap extending from the front side 12, and optionally further comprising two additional flaps extending from lateral sides 16 and 18.

After the materials to be shipped are located within the interior space, the opening 24 may be sealed by closing the flap(s) formed by the one or more lateral sides, or the equivalent, over the opening and sealing with an adhesive strip or the equivalent to close the shipping carton 10. For example, the shipping carton 10 shown in FIG. 1 may be sealed shut when the lateral side 20 is folded about the edge 26 to cover the opening 24 and the tab 28 is received in the slot 30. In embodiments comprising multiple flaps the flaps may be folded over each other to close the opening 24 and secured by adhesive or other suitable means. Any suitable closure mechanism may be used in addition to or instead of an adhesive strip or its equivalent, as the skilled artisan will recognize, all of which are known in the art and, therefore, are not described further herein. The sealed shipping carton may be opened by a tear notch or strip (e.g., a strip having a pull-tab) formed in the shipping carton, such as in the lateral side of the shipping carton that forms the flap. The shipping carton may include any other suitable mechanism by which the carton may be opened, or may simply be opened by breaking a seal formed by adhesive or tape sealing the carton.

The example shipping carton 10 of FIGS. 1 and 2 comprises a plurality of transparent sections functioning as windows to allow visual communication of the interior space of the shipping carton 10. As shown, a plurality of transparent sections 32A, 32B, and 32C may be disposed or located on front side 12 of the shipping carton 10 and a plurality of transparent sections 34A, 34B, and 34C may be disposed or located on the back side 12 of the shipping carton 10, as illustrated in FIGS. 1 and 2. The transparent sections 32A-32C and 34A-34C may comprise a width W, which may have any suitable value to facilitate the use of automated interrogation or inspection means.

In the illustrated example, the front side 12 and the back side 14 of the shipping carton 10 each comprise three transparent sections 32 or 34, with the transparent sections 32A-32C of the front side 12 being located under an address section 36. In other examples, one or both of the front side 12 and the back side 14 may comprise a single one of the transparent section sections 32 or 34, two of the transparent sections 32 or 34, or any other suitable number of transparent sections. Additionally, or alternatively, one or more of the lateral sides 16, 18, 20, and/or 22 may comprise one or more transparent sections. In any such examples, one or more of the transparent sections 32A-32C of the front side 12 may be aligned with a corresponding one of the transparent sections 34A-34C of the back side 14. In any such examples, a transparent section (e.g., the transparent sections 34A-34C) may be positioned over a corresponding opening defined in a side of the shipping carton 10. Such openings may be formed by removing portions of the primary material of the shipping carton 10 or may be integrally formed into the primary material of the shipping carton 10.

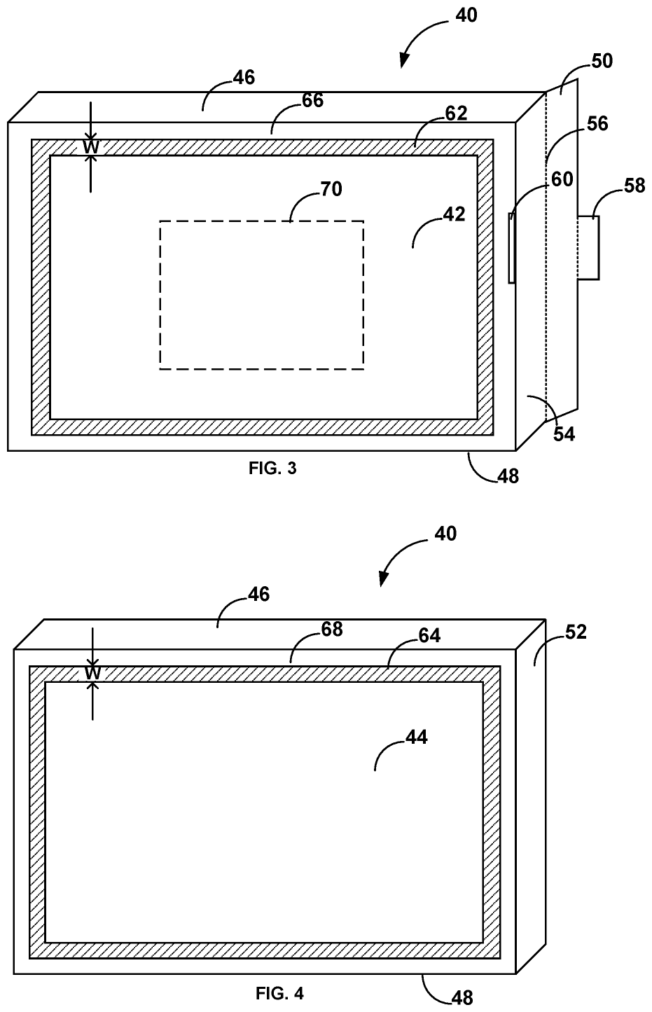

With reference to FIGS. 3 and 4, shipping carton 40 comprises a front side 42 and a back side 44. The front side 42 and the back side 44 are joined together by four lateral sides 46, 48, 50, and 52 that are adjacent the four edges of front side 42 and back side 44. The shipping carton 40 of FIGS. 3 and 4 may be substantially similar to the shipping carton 10 of FIGS. 1 and 2 in one or more respects. For example, one or more of the lateral sides 46, 48, 50, and 52 comprise one or more flaps defining a corresponding opening 54 through which materials to be shipped are slid into an interior space defined within the shipping carton 40, as is commonly known with sealable shipping cartons. In the embodiment of FIGS. 3 and 4, lateral side 50 comprises the flap. When the flap is open, the lateral side 50 is connected only to the back side 44 along edge 56, which functions as a hinge on which the flap pivots. In this embodiment, the lateral side 50 further defines a tab 58 that is dimensioned to be received in slot 60, which is defined by the front side 42. In other embodiments (not shown), the lateral side 50 may comprise two flaps, one extending from the back side 44 as shown and the other flap extending from the front side 42, and optionally further comprising two additional flaps extending from lateral sides 46 and 48.

After the materials to be shipped are located within the interior space, the opening 54 may be sealed by closing the flap(s) formed by the one or more lateral sides, or the equivalent, over the opening and sealing with an adhesive strip or the equivalent to close the shipping carton 40. For example, the shipping carton 10 shown in FIG. 1 may be sealed shut when the lateral side 20 is folded about the edge 26 to cover the opening 24 and the tab 28 is received in the slot 30. In embodiments comprising multiple flaps the flaps may be folded over each other to close the opening 24 and secured by adhesive or other suitable means. As with the shipping carton 10, any suitable closure mechanism may be used in addition to or instead of an adhesive strip or its equivalent with the shipping carton 40.

With reference to FIGS. 5 and 6, a tubular shipping carton 80 comprises a curved major surface 82, which comprises a front portion 84 and a back portion 86 contiguous with the front portion 84. The curved major surface 82 defines an interior space 88 therein that extends between a first end surface 90 and a second end surface 92, forming a tube. The first end surface 90 and second end surface 92 may comprise end caps configured to be fitted within or over the end edges of the major surface 82 to define the interior space 88 therebetween, as is commonly known with sealable tubular shipping cartons.

After the materials to be shipped are located within the interior space 88, the tubular shipping carton 80 may be sealed by attaching the first and second ends 90 and 92 to the major surface 82, such as by being fitted within or over the end edges of the major surface 82. Any suitable additional closure mechanism may be used if desired, such as adhesive glue or tape, to better secure the ends 90, 92 to the major surface 102.

The example tubular shipping carton 80 of FIGS. 5 and 6 comprises a plurality of transparent sections functioning as windows to allow visual communication of the interior space 88 of the shipping carton 80. As shown, a plurality of transparent sections 94A, 94B, and 94C may be disposed or located on front portion 84 of the major surface 82 and a plurality of transparent sections 96A, 96B, and 96C may be disposed or located on the back portion 86 of the major surface 82, as illustrated in FIGS. 5 and 6. The transparent sections 94A-94C and 96A-96C may comprise a width W, which may have any suitable value to facilitate the use of automated interrogation or inspection means.

In the illustrated example, the front portion 84 and the back portion 86 of the major surface 82 of the shipping carton 90 each comprise three transparent sections 94 or 96, with the transparent sections 94A-94C of the front portion 84 being located under an address section 98. In other examples, one or both of the front portion 84 and the back portion 86 may comprise a single one of the transparent section sections 94 or 96, two of the transparent sections 94 or 96, or any other suitable number of transparent sections. Additionally, or alternatively, one or more of the end caps 90 and/or 92 may comprise one or more transparent sections. In any such examples, one or more of the transparent sections 94A-94C of the front portion 84 of the major surface 82 may be aligned with a corresponding one of the transparent sections 96A-96C of the back portion 86 of the major surface 82. In any such examples, a transparent section (e.g., the transparent sections 94A-94C) may be positioned over a corresponding opening defined in the major surface 82 of the shipping carton 80. Such openings may be formed by removing portions of the primary material of the shipping carton 80 or may be integrally formed into the primary material of the shipping carton 80.

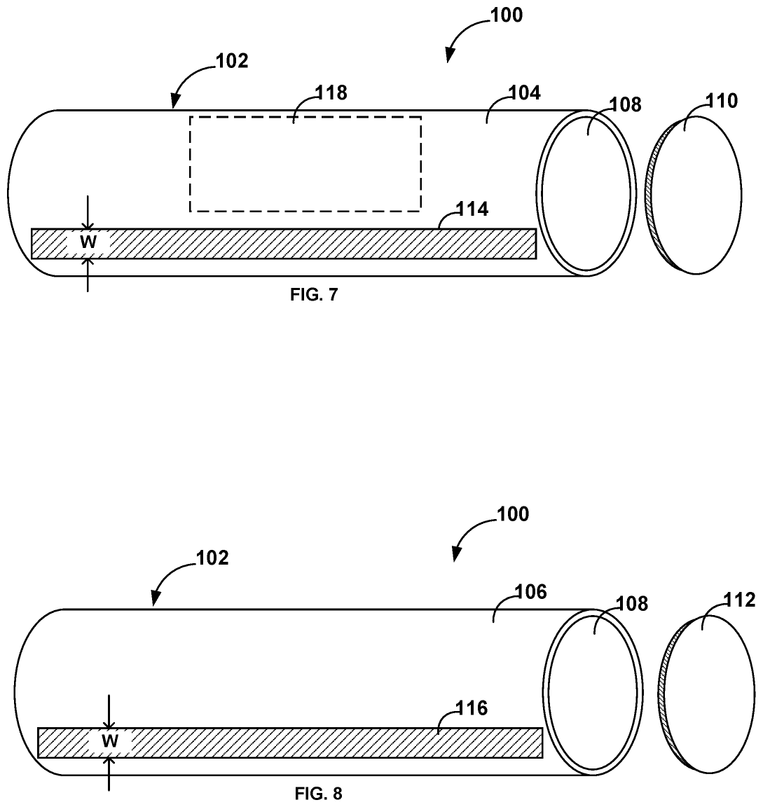

With reference to FIGS. 7 and 8, a tubular shipping carton 10 comprises a curved major surface 102, which comprises a front portion 104 and a back portion 106 contiguous with the front portion 104. The curved major surface 102 defines an interior space 108 therein that extends between a first end surface 110 and a second end surface 112, forming a tube. The shipping carton 110 of FIGS. 7 and 8 may be substantially similar to the tubular shipping carton 80 of FIGS. 5 and 6 in one or more respects. For example, the first end surface 110 and second end surface 112 may comprise end caps configured to be fitted within or over the end edges of the major surface 102 to define the interior space 108 therebetween, as is commonly known with sealable tubular shipping cartons.

After the materials to be shipped are located within the interior space 108, the tubular shipping carton 100 may be sealed by attaching the first and second ends 110 and 112 to the major surface 102, such as by being fitted within or over the end edges of the major surface 102. As with the shipping carton 80, any suitable additional closure mechanism may be used if desired, such as adhesive glue or tape, to better secure the ends 110, 112 to the major surface 102.

The example tubular shipping carton 100 of FIGS. 7 and 8 differs from the tubular shipping carton 80 in that the front portion 104 and the back portion 106 of the major surface 102 each comprise a single transparent section, respectively transparent section 114 and transparent section 116, functioning as windows to allow visual communication of the interior space 108 of the shipping carton 100. Additionally, or alternatively, one or more of the ends 110 and/or 112 may comprise one or more transparent sections. The transparent section 114 may be spaced away from an address section 118 on the front portion 104 as shown in FIG. 7. As shown in FIGS. 7 and 8, the transparent sections 114 and 116 may extend substantially from first end 110 to second end 112 along the respective front and back portions 104 and 106. The transparent sections 114 and 114 may comprise a width W. In certain configurations, width W may be greater or less than 3 mm. In a preferred configuration, width W may be approximately 5 mm to facilitate visual inspection. However, it is understood that automated interrogation or inspection means may require greater or smaller widths W; thus, the width W may have any suitable value.

In any such examples, the transparent section 114 of the front portion 106 may be aligned with the transparent section 116 of the back side 106. In any such examples, the transparent section (e.g., the transparent sections 114 and/or 116) may be positioned over a corresponding opening defined in the major surface 102 of the shipping carton 100. Such openings may be formed by removing portions of the primary material of the shipping carton 100 or may be integrally formed into the primary material of the shipping carton 100.

The following description may be applicable to any or all embodiments of the shipping cartons 10, 40, 80, and 100 described above with respect to FIGS. 1-8. For example, the transparent section(s) of the shipping cartons of the present invention may be continuous or may be broken up and spaced across the front side and/or back side of the shipping carton. The transparent section(s) may comprise a material that is sufficiently strong, flexible and transparent to allow visual access to the interior space of the shipping carton while withstanding the forces of shipping. An exemplary material may comprise polyethylene terephthalate (PET), polypropylene (e.g., oriented polypropylene (OPP)), nylon, polystyrene, though other materials will present themselves to the skilled artisan. Such materials may be formed into a film, which may be adhered or laminated onto the shipping carton. In examples in which a primary material of the shipping carton is corrugated, adhesives specially suited for adhering the film of the transparent section(s) to the corrugated material may be used.

The primary purpose of the transparent section(s) is to provide visual access into the interior space to inspect or interrogate the interior space for dangerous or otherwise unauthorized substances or objects such as dangerous powders, illicit drugs, explosives, weapons, or the like. Thus, the remaining portions of front, back, lateral, and/or major sides and/or ends of the shipping carton (i.e., those not defined by the transparent section(s)), are substantially opaque and preferably opaque.

Such inspection may be done manually or by aid of machines adapted to identify such substances or objects. Various means for automated inspection or interrogation of the interior space of the shipping carton using machines are known in the art and may include, without limitation, taking images of the interior space via the transparent section wherein the images are photographic and/or transmit energy within the visible wavelength spectrum or may be within other regions of the wavelength spectrum such as infrared. Thus, energy may be transmitted to, and in some cases through, the transparent section(s) at least one wavelength and at least one frequency. These images may be compared with a reference database for evidence of the presence of dangerous or otherwise unauthorized substances or objects or evaluated by other means known to the skilled artisan.

As discussed above with respect to the figures, the shipping cartons of the present invention may include a front side comprising one or more transparent sections and a back side comprising one or more transparent sections, in the case of a box-shaped carton, or front and back portions of a major surface comprising one or more transparent sections in the case of a tubular shipping carton. Including at least one transparent section on each of the front side/portion and the back side/portion of the shipping carton advantageously may enable machines used for automated detection or inspection of the interior space of the shipping carton regardless of whether the front side/portion or the back side/portion of the shipping carton is facing toward the machine used for automated detection or inspection.

For example, shipping cartons commonly may be placed on and transported by a conveyor belt in a shipping facility during processing of the cartons. During transportation by the conveyor belt, shipping cartons having the general shape shown in FIGS. 1-4 (i.e., a box shape having two major sides) are likely to rest on either the front side of the carton or the back side of the carton. As the machines used for automated detection or inspection of the interior space of the shipping carton are likely to be positioned above the conveyor belt, a shipping carton that includes at least one transparent sections on each of the front and back sides of the carton will have at least one transparent section oriented toward such a detection or inspection machine regardless of whether the shipping carton is resting on its front or back side. Additionally, or alternatively, any of the shipping cartons described herein may comprise one or more transparent sections in one or more of the lateral sides of the shipping carton. In any such examples, shipping cartons comprising transparent section(s) in more than one side of the carton may reduce the possibility of dangerous or otherwise unauthorized substances or objects contained within the shipping carton escaping detection. In the case of tubular shipping cartons having the general shape shown in FIGS. 5-8, having at least one transparent section in each of the front and back portions of the major surface of the tube make it likely that the tubular shipping carton will have at least one transparent section oriented toward a detection or inspection machine.

The automated inspection or interrogation may further search along at least a portion of the transparent section(s) for evidence of an opaqueness or transmissibility of light or other energy that is inconsistent with the transmissibility of a non-contaminated transparent section(s). Stated differently, interrogating energy from an interrogating machine may be substantially aligned with or focused on or move along at least a portion of the transparent section to discover potentially dangerous regions where something such as a powder may be affixed to the interior surface of the transparent section(s). When such contamination evidence is discovered, the shipping carton may then be flagged for further inspection.

Thus, it will now be apparent that in certain embodiments, it will be advantageous for at least one transparent section positioned on the a first (e.g., front) side/portion of the shipping carton and at least one transparent section positioned on a second, opposing (e.g., back) side/portion of the shipping carton to be at least partially substantially aligned to facilitate the inspection and/or interrogation of the interior space of the shipping carton, whether done manually or automatedly. In some cases, a scanner may be used to inspect or interrogate the interior space.

The location of the at least one transparent section is preferably spaced away from the usual location of a mailing address or customs-documentation section on the front side of the shipping carton. In some examples, the transparent section(s) may be positioned, sized, and/or shaped to preserve confidentiality of the materials sealed within the interior space of the shipping carton while allowing some visual access into the interior space. However, the transparent section(s) may have any suitable sizes, shape, and/or position relative to other features of the shipping carton.

Thus, the shipping cartons described above with respect to the present invention include least one transparent section that is positioned, shaped and/or sized to allow visual access to the interior of the carton without compromising the integrity and privacy of the shipped materials.

Other configurations for transparent section(s) will now become available to the skilled artisan, each of which is within the scope of the present invention. Without limitation, the transparent section(s) of the shipping cartons may: comprise regular or irregular shapes; may be continuous or discontinuous; may be a single section or may comprise a plurality of sections; may be disposed on any one or more of the front, back, and lateral sides of the shipping carton; and all, some, or none of transparent section(s) may be aligned with one another.

In the case of a geometric shape, whether regular or irregular, the width of the transparent section(s) of the shipping cartons described herein may, as discussed above, be sized to accommodate visual and/or automated inspection or interrogation of the interior space of said shipping cartons.

It is preferred that the front and/or back sides of the shipping cartons, or the major outer surface in the example of a tube-shaped carton, be coated at least partially with a matte coating that reduces and/or eliminates the glossiness or glossy quality of the front, back, and/or other sides in the opaque region thereof. This construction may assist in the automated inspection and/or interrogation of the interior space of the shipping carton through the transparent section(s).

The shipping cartons of the present invention may include shipping cartons sold by known shipping entities, such as the U.S. Postal Service, FedEx, DHL, Amazon, and UPS.

The present invention should not be considered limited to the particular examples described above, but rather should be understood to cover all aspects of the invention. Various modifications, equivalent processes, as well as numerous structures to which the present invention may be applicable will be readily apparent to those of skill in the art to which the present invention is directed upon review of the present specification.

What is claimed is:

1. A shipping carton comprising a front side defining four front edges and a back side defining four back edges, the front and back sides joined together by four lateral sides, the four lateral sides positioned between the front and back sides such that the shipping carton defines an interior space extending between the front, back, and lateral sides, wherein the front side comprises at least one front transparent section in visual communication with the interior space and the back side comprises at least one back transparent section in visual communication with the interior space.

2. The shipping carton of claim 1, wherein one of the four lateral sides comprises a flap defining a sealable opening to the interior space.

3. The shipping carton of claim 1, wherein the at least one front transparent section comprises a plurality of front transparent sections.

4. The shipping carton of claim 1, wherein the at least one back transparent section comprises a plurality of back transparent sections.

5. The shipping carton of claim 1, wherein one or more of the at least one front transparent section is substantially aligned with one or more of the at least one back transparent section.

6. The shipping carton of claim 1, wherein one or both of the at least one front transparent section and the at least one back transparent section comprise one continuous transparent section.

7. The shipping carton of claim 1, wherein the front side comprises a mailing address section spaced away from the at least one front transparent section.

8. The shipping carton of claim 1, wherein the remainder of the front and back sides not comprising the corresponding at least one front transparent section and the at least one back transparent section are opaque.

9. The shipping carton of claim 8, wherein the opaque portions of the front side and/or the back side comprise a matte coating thereon.

10. A tubular shipping carton comprising:
a curved major surface comprising a front portion, a back portion contiguous with the front portion;
a first end surface; and
a second end surface,
wherein the major surface is positioned between the first and second end surfaces such that the shipping carton defines an interior space extending between the first and second end surfaces, and
wherein the front portion of the major surface comprises at least one front transparent section in visual communication with the interior space and the back portion comprises at least one back transparent section in visual communication with the interior space.

11. The shipping carton of claim 10, wherein at least one of the first end surface comprises a removable cap providing access to the interior space.

12. The shipping carton of claim 10, wherein the at least one front transparent section comprises a plurality of front transparent sections.

13. The shipping carton of claim 10, wherein the at least one back transparent section comprises a plurality of back transparent sections.

14. The shipping carton of claim 10, wherein one or both of the at least one front transparent section and the at least one back transparent section comprise one continuous transparent section.

15. The shipping carton of claim 10, wherein one or more of the at least one front transparent section is substantially aligned with one or more of the at least one back transparent section.

16. The shipping carton of claim 10, wherein at least one of the first end surface and the second end surface comprises a transparent section.

17. The shipping carton of claim 10, wherein the front portion of the major surface comprises a mailing address section spaced away from the at least one front transparent section.

18. The shipping carton of claim 10, wherein the remainder of the front and back portions of the major surface not comprising the corresponding at least one front transparent section and the at least one back transparent section are opaque.

19. The shipping carton of claim 19, wherein the opaque portions of the front and/or the back portions of the major surface comprise a matte coating thereon.

20. A method for assessing a closed and sealed shipping carton for potentially dangerous substances or objects disposed within the carton comprising:
receiving a closed and sealed shipping carton according to one of the shipping carton of claim 1 and the shipping carton of claim 10;
inspecting the interior space of the received shipping carton through one or more of the at least one front transparent section and the at least one back transparent section for potentially dangerous substances or objects; and
determining if the interior space of the closed and sealed enveloping container contains a potentially dangerous substance or object.

21. The method of claim 20, wherein inspecting comprises scanning by a scanner.

22. The method of claim 20, wherein inspecting comprises transmitting energy of at least one selected wavelength and at least one frequency through the at least one transparent sections of the front side and the back side.
